(19) United States
(12) Patent Application Publication
(10) Pub. No.: US 2008/0311353 A1
(43) Pub. Date: Dec. 18, 2008

(54) REINFORCED FABRIC HAVING A THERMALLY FUSED MAT

(75) Inventor: Louis Kevin Horne, Salem, AL (US)

Correspondence Address: FAY SHARPE LLP, 1100 SUPERIOR AVENUE, SEVENTH FLOOR, CLEVELAND, OH, 44114, US

(73) Assignee: Garland Industries, Inc.

(21) Appl. No.: 12/141,182

(22) Filed: Jun. 18, 2008

Related U.S. Application Data
(62) Division of application No. 11/652,058, filed on Jan. 10, 2007.

(51) Int. Cl. B32B 3/00; D04H 13/00

(52) U.S. Cl. 428/190; 28/140

(57) ABSTRACT

A reinforced fabric comprising a fiber group and a mat. The fiber group includes a plurality fibers positioned substantially parallel to one another. The mat is formed of a plurality of threads that intersect one another and are connected together. The mat has an outer surface that is formed of a material having a melting point that is less than the melting point of the fibers. At least a portion of the mat is heat bonded to a plurality of the fibers to at least partially maintain the fibers in position relative to one another.

The present invention is a divisional application of co-pending U.S. patent application Ser. No. 11/652,058 filed Jan. 10, 2007.

The present invention relates to a reinforced fabric, and particularly to a reinforced fabric that is formed by woven and/or non-woven fibers that are held in position by a mat, and more particularly to a reinforced fabric that is formed by woven and or non-woven fibers that are held in position by a mat that is at least partially melted to the woven and/or non-woven fibers.

### BACKGROUND OF THE INVENTION

Reinforcement fabrics are used in many industries for adding strength to composite materials. Such reinforcement fabrics are, in fact, generally referred to as composite reinforcements.

The reinforcement fabrics are typically formed in a location that is remote from place and time to the use of the reinforcement fabric. As such, it is necessary to maintain the fibers of the fabric in a predetermined configuration from the point of manufacture until the time of use. Typically, the reinforcement fabrics are stitched together or adhesively secured together to maintain the fibers in position. Although the use of stitching is generally effective to hold the fibers together, the stitching has some play, thus enabling the fibers to shift during transport of the reinforced fabric, thereby potentially compromising the strength and/or rigidity of the reinforcement fabric. Stitching of the fibers together inherently provides relatively large loops or other closed circuits of the stitching. When reinforcing fabrics are stitched together in the manner known in the prior art, any activity which causes breaks in the stitching or pulls the stitching out of place can result in an undesired disruption of the fiber matrix which the stitching has created. For example, cutting the reinforcement fabric, snagging the stitching and the like, can result in “unzipping” the stitching, thereby destroying the predetermined fiber orientation on the reinforcement fabric. Likewise, when the reinforcement fabric is cut into sections for use in a particular application, the stitching is severed at the ends of the reinforcement fabric and can result in the “unzipping” of the stitching. In order to address these problems, the stitching thread can be melted onto the fibers of the reinforcement fabric to lock the fibers in place. An example of such a fabric is disclosed in U.S. Pat. No. 5,795,835. Although the locking of the fibers by melting of the stitching thread maintains the fibers in rigid place with respect to one another, the flexibility of the reinforcement fabric is significantly reduced. In many applications, the reinforcement fabric is wrapped about a structure (e.g., pole, column, etc.) to provide support and/or strength to such structure. When the stitching on the reinforcement fabric is melted onto the fibers, the stitching is susceptible to breaking when the reinforcement fabric is wrapped about a structure. The breaking of the stitching can compromise the strength and durability of the reinforcement fabric. Similarly, when the fibers are connected together by an adhesive, the bending of the reinforcement fabric can cause the adhesive to break and/or release from the fibers, thereby compromising the strength and durability of the reinforcement fabric.

When reinforcement fabrics are impregnated with a liquid material, the adhesive on the reinforcement fabric is susceptible to softening or dissolving, thereby compromising the strength and durability of the reinforcement fabric. The softening or dissolving of the adhesive can also result in the movement of the fibers during the impregnation process, thereby potentially compromising the strength, durability and/or quality of the final product. In addition, certain adhesives can adversely affect the ability of the impregnating liquid to fully wet and saturate the fibers in the reinforcement fabric, thereby adversely affecting the strength, durability and/or quality of the final product. Furthermore, the impregnation process generally works best when the fibers on the reinforcement fabric are held together in only a proximal relationship, but are not affixed to one another, to allow the penetration of the impregnating liquid about the fibers.

In an effort to address the past problems of reinforced fabrics, a new type of reinforced fabric disclosed in WO 02/04725 was developed, which is incorporated herein by reference. The reinforced fabric was designed to be useful in the formation of reinforcing composite materials. The reinforced fabric is formed of at least first and second sets of fibers wherein the first set of fibers is laid as a ply in a spaced apart parallel relationship in the direction of construction and the second set of fibers are laid as a ply in a spaced apart parallel relationship which is perpendicular to the direction of construction. These two sets of fibers define interstices into which a continuous filament is knitted to provide stability. The filament has a core portion and a sheath portion having a lower melting point than the core portion. The sheath portion is thermally fusible to form a plurality of closed loops in which the respective sets of fibers are entrapped.

Although the reinforced fabric disclosed in WO 02/04725 solves many of the problems associated with past reinforced fabrics, some types of fabrics are difficult to stitch to form a stable fiber structure. In addition, when all of the fibers are laid generally parallel to one another, stitching of the fabric may not provide a stable and/or satisfactory reinforced fabric. As such, there is a need for a reinforced fabric and method for making such a fabric that overcomes these past problems.

### SUMMARY OF THE INVENTION

The present invention is directed to a reinforced fabric that can be used alone or subsequently processed (e.g., partially or fully impregnated with a material, etc.) to provide structural support, rigidity, etc. to a variety of structures (e.g., roofing materials, building siding materials, poles, support columns, fiber composite panels [i.e., fiberglass panels, etc.], boat hulls, flooring, pavements, etc.). These reinforced fabrics can be impregnated with a liquid material, such as a resin, a bitumen or the like to form a composite material; however, this is not required. These reinforced fabrics can be secured to a base structure (e.g., wood board, concrete wall, wood or composite column or pole, etc.) by a mechanism (i.e., nail, tact, staple, etc.) and/or by an adhesive to provide additional strength and/or rigidity to the base structure. The reinforced fabric can be coated with one or more coatings (e.g., paint, resins, plastic, etc.) to provide further strength and/or rigidity to the base structure and or to create the desired look or finish for the final product. The reinforced fabric is formed by a plurality of fibers that are at least partially held together and at least partially held in position by one or more mats. The fibers used in the reinforced fabric can be woven fibers, non-woven fibers or some mixture thereof. The mat used in the reinforced fabric is selected to have an outer surface that has a melting point that is less than the melting point of the surface of one or more fibers in the reinforced fabric. The reinforced fabric does not require any stitching of the fibers as in past reinforcement fabrics to maintain the fibers in position relative to one another. However, it can be appreciated that the reinforced fabric can include stitching; however, such stitching is not required.

In one non-limiting aspect of the present invention, many different types of fiber materials can be used to form the reinforced fabric. The reinforced fabric can be formed of the same or different compositional type of fibers. The fibers in the reinforced fabric can have the same or different size and/or shaped cross-sectional area. The fibers in the reinforced fabric can have the same or different color. In one non-limiting embodiment of the invention, the fibers can include materials such as, but not limited to glass fibers (e.g., silica glass, aramid glass, etc.), carbon fibers, quartz fibers, Kevlar® fibers, boron fibers, polyethylene fibers, polyamide fibers, polypropylene fibers, etc. The fibers can be formed of a single material or be a hybrid of one or more materials. In another and/or additional non-limiting embodiment of the invention, a majority of the fibers in the reinforced fabric are non-woven fibers. In still another and/or additional non-limiting embodiment of the invention, a majority of the fibers in the reinforced fabric are woven fibers such as, but not limited to, a roving of fibers. In yet another and/or additional non-limiting embodiment of the invention, several sets of fibers are oriented together and then at least partially secured in position relative to one another to form the reinforced fabric. In one non-limiting aspect of this embodiment, at least one set of fibers is formed of a plurality of fibers. The shape, size, color and/or composition of the fibers in each set of fibers can be the same or different. In one non-limiting design, the shape, size and composition of a majority of the fibers in at least one set of fibers are substantially the same. In another and/or additional non-limiting design, a majority of the fibers in at least one set of fibers are non-woven fibers (e.g., laid fibers, etc.). In still another and/or additional non-limiting design, a majority of the fibers in at least one set of fibers are woven fibers. In yet another and/or additional non-limiting design, at least a portion of the fibers in at least one set of fibers are non-woven fibers and at least a portion of the fibers are non-woven fibers. For instance, the core of a set of fibers could be woven or non-woven fibers and the outer region of the set of fibers could be formed of non-woven or woven fibers.

In another and/or additional aspect of the present invention, many types of mats can be used in the reinforced fabric. The mat can be made of a single material or a composite material. The mat can have the same or different shape, color and/or size from the fibers used in the reinforced fabric. As used herein, “mat” is defined to include a mat material, a mesh material, a scrim or any other material that includes one or more threads of material that intersect and/or overlay one another to form a layer of material. The one or more threads in the mat can be woven or non-woven. The mat typically has a generally uniform thickness along the longitudinal length of the mat; however, this is not required. The design of the mat is non-limiting; as such many different types of mat configurations can be used in the present invention. The overlapping threads in the mat can be stitched together, adhesively bonded together, melted or fused together, connected together by one or more coatings, or connected together in other or additional ways; however, it will be appreciated that the overlapping threads need not be connected together. In one non-limiting embodiment of the invention, the mat is formed of a single material. The single material that forms the mat is selected to have a melting point that is less than the surface of a majority of the fibers contacted by the mat. In one non-limiting aspect of this embodiment, the mat is formed of a polymer material that includes a material such as, but not limited to, nylon, polyester, polypropylene, polyethylene, polyurethane, poly(meth)acrylate, etc. In another and/or additional non-limiting embodiment of the invention, the mat is formed of a plurality of materials. In one non-limiting aspect of this embodiment, the mat includes an outer coating material and a core material. The outer coating material typically has a different melting point temperature than the core material. In one non-limiting design, the core has a higher melting point than the outer coating material. In one non-limiting particular aspect of this design, the material forming the core has a melting point temperature that is at least about 10° F. greater than the outer coating material, typically at least about 20° F. greater than the outer coating material, more typically at least about 30° F. greater than the outer coating material, and still even more typically at least about at least about 40° F. greater than the outer coating material. In another and/or alternative non-limiting particular aspect of this design, the material of the core includes a lower viscosity polyester (e.g., polyethylene terephthalate polyester, etc.) and the outer coating includes polypropylene, polyethylene, polyurethane, poly(meth)acrylate, high melting point polyester, and copolymers thereof. In still another and/or additional non-limiting embodiment of the invention, the outer surface of the mat has a melting point temperature that is at least about 50° F. greater than the outer surface of a plurality of fibers in the reinforced material, typically at least about 100° F. greater than the outer surface of a plurality of fibers in the reinforced material, more typically at least about 200° F. greater than the outer surface of a plurality of fibers in the reinforced material, and still even more typically at least about 400° F. greater than the outer surface of a plurality of fibers in the reinforced material.

In still another and/or additional aspect of the present invention, the reinforced fabric includes a fiber group that includes plurality of fibers that are laid in a generally parallel relationship to one another. The fiber group can be formed of one set of fibers or a plurality of sets of fibers. When the fiber group is formed from a plurality of fiber sets, one or more of the fibers sets can be spaced next to one another, overlap one another, or be spaced apart from one another. When the fiber group is formed by a plurality of fiber sets, each fiber set generally has the same number of fibers; however, this is not required. The number of fibers in a fiber set generally is about 2-500000, and typically about 5-10000, and more typically about 10-1000; however, other numbers of fibers in a fiber set can be used. Typically the fiber set includes a plurality of layers of fibers; however, this is not required. The thickness of at least one fiber set is generally at least about 0.05 mm, and typically at least about 0.1 mm; however, other thickness can be used. The width of a fiber set is generally greater than the thickness of the fiber set; however, this is not required. Typically the width of at least one fiber set is at least about 0.5 mm, and more typically at least about 1 mm; however, other widths can be used. When a plurality of fiber sets are spaced apart from one another, the fiber sets are spaced at generally the same distance apart from one another; however, this is not required. Each set of fibers is generally formed of the same material; however, this is not required. As can be appreciated, each set of fibers can be formed of the same type of material or same mixture of materials, however, this is not required.

In yet another and/or additional aspect of the present invention, the reinforced fabric includes at least two fiber groups. The fiber groups can be laid in a parallel or non-parallel relationship to one another. The fibers in each group can be the same or different material. Each fiber set in each fiber group has generally the same number of fibers; however, this is not required. When two or more fiber groups are positioned in a non-parallel relationship to one another, one fiber group has an angular orientation to another fiber group of about 10-90°. In one non-limiting design of this aspect, the one fiber group is laid at least partially on another fiber group so as to form an angular orientation that is generally perpendicular. As can be appreciated, more than two fiber groups can be used to form the reinforced fabric. These fiber groups can be positioned parallel or non-parallel to one another.

In yet another and/or additional aspect of the present invention, the one or more mats used to at least partially maintain the relative position of the one or more fiber groups are at least partially secured to a plurality of fibers by a heat-created bond. In one non-limiting embodiment of the invention, one or more mats are positioned on the top and/or bottom of the one or more fiber groups. The one or more mats can be positioned on part of or the complete top and/or bottom side of the one or more fiber groups. All or part of the one or more mats can be heat bonded to one or more fibers in the one or more fiber groups. In one non-limiting embodiment of the invention, a mat is secured to one or more fibers in the reinforced fabric. In another and/or additional non-limiting embodiment of the invention, the mat is formed of a plurality of intersecting threads and has a plurality of openings. In one non-limiting aspect of this embodiment, the mat includes crosshatched threads that are position generally perpendicular to one another and the openings in the mat are generally square shaped. As can be appreciated, the mat can have many other configurations. In still another and/or additional non-limiting embodiment of the invention, when forming the reinforced fabric, the mat can be applied to the one or fiber groups after the laying of the one or more fiber groups. In yet another and/or additional non-limiting embodiment of the invention, when forming the reinforced fabric, the mat can be laid first and then one or more fiber groups can be laid on the mat or mesh. As can be appreciated, the order at which the one or more fiber groups and/or one or more mats are laid is non-limiting. In still yet another and/or additional non-limiting embodiment of the invention, the spacing and/or configuration of the mat can be selected to provide the designed flexibility of the reinforced fabric. For instance, a multi-layered mat and/or a mat that has a higher density of threads can result in reducing the flexibility of the reinforced fabric; however, the strength and/or rigidity of the reinforced fabric may be increased. In another and/or additional non-limiting embodiment of the invention, the reinforced fabric includes one or more mats on the outer surface of the reinforced fabric. In one non-limiting aspect of this embodiment, the reinforced fabric includes a mat on only one outer surface of the reinforced fabric. The one or more mats can be on part of or on the complete outer surface of the reinforced fabric. In another non-limiting aspect of this embodiment, the reinforced fabric includes one or more mats on both outer surfaces of the reinforced fabric. The one or more mats can be on part of or on the complete outer surface of one or both sides of the reinforced fabric. In still another and/or additional non-limiting embodiment of the invention, the reinforced fabric includes one or more mats positioned at least partially between the two outer surfaces (i.e., an interior surface) of the reinforced fabric. In one non-limiting aspect of this embodiment, the reinforced fabric includes one or more mats on part of or on the complete interior surface of the reinforced fabric. As can be appreciated, the reinforced fabric can also include one or more mats on one or both outer surfaces of the reinforced fabric. In such a arrangement, the one or more mats can be on part of or on the complete outer surface of one or both sides of the reinforced fabric. Likewise, the reinforced fabric can include one or more mats on part of or on the complete interior surface of the reinforced fabric.

In still another and/or additional aspect of the present invention, the reinforced fabric includes a plurality of mats that are heat bonded together in one or more locations on the reinforced fabric so as to at least partially entrap one or more fibers between the two or more mats. The at least partial entrapment of a plurality of fibers between the two or more mats results in at least partially maintaining the position of the fibers of the reinforced fabric. In one non-limiting embodiment of the invention, one or more side edges of the reinforced fabric are heat bonded together. In another and/or additional non-limiting embodiment of the invention, regions spaced inwardly from one or more side edges of the reinforced fabric are heat bonded together.

In still another and/or additional aspect of the present invention, the reinforced fabric is exposed to and/or heated to a temperature that is at least about 50° F. less than the melting point or thermal degradation temperature of the outer surface of the fibers that are in contact with the one or more mats and at least about 1° F. greater than the softening point or melting point of the outer surface of at least one of the one or more mats that contact the fibers for a time period of at least about 5 seconds to cause at least a portion of the one or more mats to heat bond to a plurality of fibers in the reinforced fabric. As can be appreciated, the heating process can also be used to bond together one or more intersecting threads in the mat; however, this is not required. As such, the heat can be used to bond the mat to the fibers in the reinforced fabric and to also bond together portions of the mat together. However, it can be appreciated, portions of the mat can be bonded together prior to bonding the mat to the fibers. In one non-limiting aspect of this embodiment, the reinforced fabric is exposed to and/or heated to a temperature that is at least about 100° F. less than the melting point or thermal degradation temperature of the outer surface of the fibers that are in contact with the one or more mats and at least about 2° F. greater than the softening point or melting point of the outer surface of the one or more mats that contact the fibers for a time period of at least about 10 seconds to cause at least a portion of the one or more mats to heat bond to a plurality of fibers in the reinforced fabric. In another and/or additional non-limiting aspect of this embodiment, the reinforced fabric is exposed to and/or heated to a temperature that is at least about 200° F. less than the melting point or thermal degradation temperature of the outer surface of the fibers that are in contact with the one or more mats and at least about 5° F. greater than the softening point or melting point of the outer surface of the one or more mats that contact the fibers for a time period of at least about 10-3600 seconds to cause at least a portion of the one or more mats to heat bond to a plurality of fibers in the reinforced fabric. In still another and/or additional non-limiting aspect of this embodiment, the reinforced fabric is exposed to and/or heated to a temperature that is about 300° F. less than the melting point or thermal degradation temperature of the outer surface of the fibers that are in contact with the one or more mats and at least about 5° F. greater than the softening point or melting point of the outer surface of the one or more mats that contact the fibers for a time period of about 10-3600 seconds to cause at least a portion of the one or more mats to heat bond to a plurality of fibers in the reinforced fabric. In another and/or alternative non-limiting embodiment of the invention, the reinforced fabric is substantially uniformly exposed to and/or heated to a temperature for a period of time that causes at least a portion of the one or more mats to heat bond to a plurality of fibers in the reinforced fabric. In still another and/or alternative non-limiting embodiment of the invention, the reinforced fabric is selectively exposed to and/or heated to a temperature for a period of time that causes at least a portion of the one or more mats to heat bond to a plurality of fibers in only a portion of the reinforced fabric. Consequently, a pattern of heat bonded and non-heat bonded regions on the reinforced fabric are formed. This pattern of heat bonding and non-heat bonding can be used to customize the reinforced fabric for a variety of applications. In still yet another and/or alternative non-limiting embodiment of the invention, a plurality of fibers that are entrapped between two or more layers of mats and the at least one of the fibers are able to at least partially move relative to the one or more layers of the mat. In this arrangement, the fibers in the reinforced fabric are able to move relative one or more layers of mats to provide some play and flexibility to the reinforced fabric, especially when the reinforced fabric is folded, bend and/or wrapped about a structure. In one aspect of this embodiment, the one or more mats form a heat bond with a plurality of fibers such that the formed bond does not easily disengage from the plurality of fibers when the reinforced fabric is folded, bend and/or wrapped about a structure, and furthermore a plurality of other fibers in the reinforced fabric do not heat bond with the one or more mats. As such, in this arrangement some of the fibers heat bond to the one or more mats and some of the fibers do not bond to the one or more mats.

In another and/or additional aspect of the present invention, at least a portion of the reinforced fabric is impregnated with one or more polymer materials to form a reinforced composite material. Many types of polymers can be at least partially impregnated in the reinforced fabric. Such polymers include, but are not limited to, bitumen, asphalt, tar, various types of resins, various types of resin epoxies, polyester, polypropylene, polyethylene, polyurethane, polyacrylate, and copolymers thereof. The one or more polymers can be used to partially or fully impregnate all of or only a portion of the reinforced fabric. The one or more polymers are typically applied to the reinforced fabric by a dipping process and/or a spray coating process; however, other or additional coating processes can be used.

One non-limiting object of the present invention is the provision of a reinforced fabric that includes at one mat or mesh that is heat bonded to a plurality of fibers maintain a plurality of fibers in relative position to one another.

Another and/or additional non-limiting object of the present invention is the provision of a reinforced fabric that includes one or more regions having a plurality of fibers heat bonded to one or more mats or meshes.

These and other advantages will become apparent to those skilled in the art upon the reading and following of this description taken together with the accompanying drawing.

### BRIEF DESCRIPTION OF THE DRAWINGS

Reference may now be made to the drawings, which illustrates non-limiting embodiments that the invention may take in physical form and in certain parts and arrangements of parts wherein:

FIG. 1 is a schematic partial perspective of a mat that can be used in the reinforced fabric in accordance with the present invention;

FIG. 2 is a schematic partial perspective of fibers and mat that form a reinforced fabric in accordance with the present invention;

FIG. 3 is an enlarged section of the reinforced fabric of FIG. 2 illustrating the heat created bonds between the mat and the fibers of the reinforced fabric; and,

FIG. 4 is an enlarged cross-sectional view of the reinforced fabric of FIG. 2 illustrating a plurality of fibers positioned between two mats.

### DETAILED DESCRIPTION OF THE INVENTION

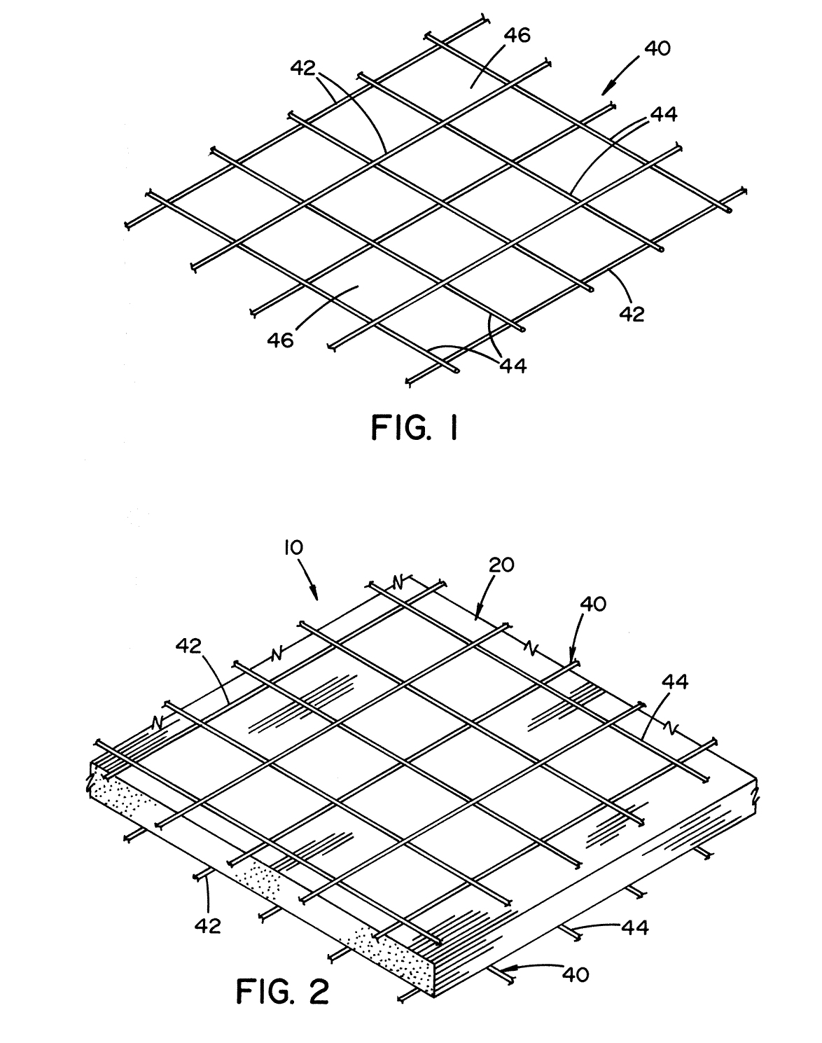

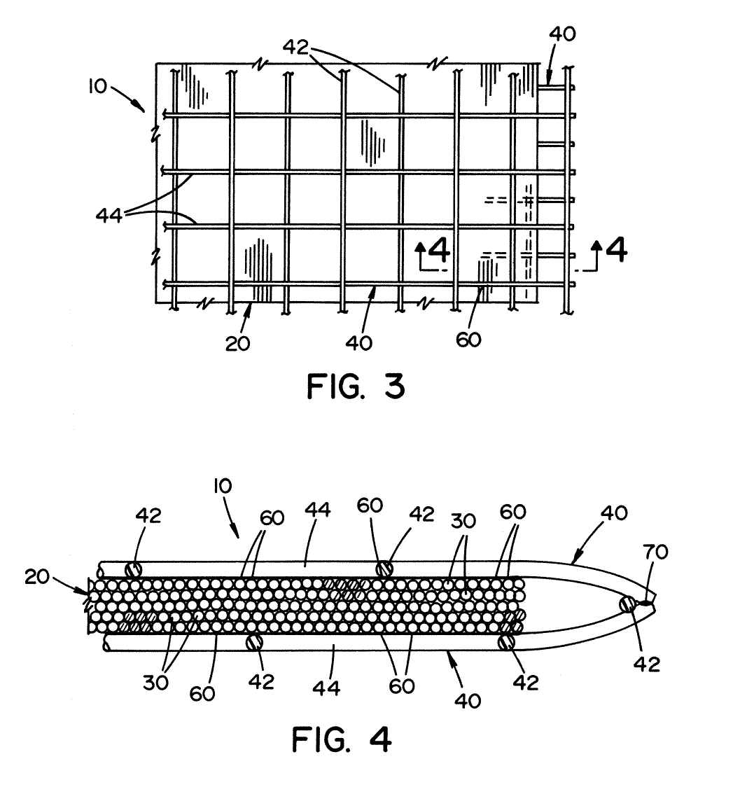

Referring now to the drawings wherein the showings are for the purpose of illustrating non-limiting embodiments of the invention only and not for the purpose of limiting the same, FIG. 2 illustrates a reinforced fabric 10. The reinforced fabric 10 includes a fiber group 20 formed of a plurality of fibers oriented generally parallel to one another. As can be appreciated, the reinforced fabric 10 can be formed of only one fiber group, formed of two fiber groups, formed of three fiber groups, or formed of more than three fiber groups. FIG. 2 is merely illustrative of one or many types of reinforced fabrics that are encompassed by the present invention. The fibers forming the fiber group can form a single layer or multiple layers of fibers. As illustrated in FIG. 4, fiber group 20 is formed of about five layers of fibers 30.

The fibers that form fiber group 20 can be of the same or different material. The fibers in each set of fibers are illustrated as non-woven fibers; however, this is not required. In one non-limiting example, the fibers include carbon fibers.

The reinforced fabric 10 is typically constructed in a specific direction. When the reinforced fabric is formed of one fiber group 20, fiber group 20 is first laid generally parallel to the construction direction and spaced at a generally equal distance apart from one another. As can be appreciated, the fiber group can be oriented in other manners relative to the construction direction and/or spaced in other manners. Once fiber group 20 is laid, one or more mats 40 are laid on the fiber group. As can be appreciated, mat 40 can be laid simultaneously with the fiber group or laid before the fiber group. The order of laying a particular component of the reinforced fabric can be thus selected based on a particular manufacturing process.

An example of one type of mat 40 that can be used in the reinforced fabric 10 is illustrated in FIG. 1. The mat is formed of two sets of threads 42, 44 positioned generally perpendicular to one another and spaced apart from one another. The mat includes generally rectangular or square shaped openings 46. As can be appreciated, many other mat configurations can be used. The intersecting threads on the mat are typically connected together; however, this is not required. In one non-limiting arrangement, the threads are heat bonded together; however, it will be appreciated that the threads can be connected together in other ways.

As illustrated in FIG. 4, mats 40 are not stitched to any portion of fibers 30. As can be appreciated, one or more of the mats can be stitched to fibers 30 if so desired. During the formation of the reinforced fabric as illustrated in FIG. 4, fibers 30 of fiber group 20 can be drawn between the two mats 40 so that the mats are positioned on the top and bottom surface of the reinforced fabric.

The threads used in mats 40 are selected such that the outer surface of the threads have a melting or softened temperature that is less than the melting or softened temperature of fibers 30. In one non-limiting arrangement, the fibers are formed of carbon fibers having a softening temperature of over 2000° C. and the threads 42, 44 of mats 40 have a polymer outer surface with a melting temperature of less than about 500° C. The threads of the mat can be formed of a single material or formed from different layers of material (e.g., a core material and an outer coating material, etc.). The threads that form the mat generally have an average cross-sectional area that is generally greater than the average cross-sectional area of the fibers; however, this is not required. Once the mats are positioned on both sides of the fibers, all or a portion of the reinforced fabric is heated to a temperature that is substantially below the melting or degrading temperature of fibers 30 and above the melting point of the outer surface of threads 42, 44. The at least partial melting of the outer surface of the threads results in a heat bonded layer 60 formed between the threads of the mats to the top surface of the fibers as illustrated in FIG. 4. As can be appreciated, one set of threads on the mat 40 can have a different outer surface soften point than other threads on the mat. If this type of mat is used, then the heat bonding between the certain thread and the fibers can occur while other threads on the mat may not become heat bonded with the fibers. As such, the mat can be designed to selectively bond with the fibers by selecting various types of threads in the mat. When the fiber group includes a plurality of fiber layers, not all of the fibers may form a bond with the mats as illustrated in FIG. 4. The reinforced fabric is generally heated for a period of time and at a temperature so as to inhibit or prevent the complete melting of the threads of the mats. Full melting of the threads can result in the damaging or breaking of one or more portions of the mats. Generally, the fibers that are bonded to the mat form a generally strong bond. As used herein “strong bond” or “strongly bonded” or “strong bonding” is defined as a bond between one or more fibers and the mat that 1) results in damage (e.g., tearing, breaking, cracking, shredding, etc.) to the one or more fibers and/or to the mat when the one or more fibers and mat are separated from one another, and/or 2) does not allow the fibers to easily disengage from the thread and move relative to the mat when the reinforced fabric is bent, folded or wrapped about another structure. For example, if a fiber that was bonded to the mat could not be easily pulled from the reinforced fabric, this would constitute a strong bond between the fiber and the mat.

The formation of the bond between the mat and the fibers can be accomplished in a variety of ways. Typically, the reinforced fabric is directed between one or more sets of rollers wherein at least one of the rollers is a heated roller. As the reinforced fabric is fed between the rollers, the heat from one or more of the rollers causes the threads on the mats to be heated and to form a heat-created bond between the mats and at least a portion of the fibers in the reinforced fabric. The one or more sets of rollers can also be used to compress the one or more mats and fibers in the one or more fiber groups together to form a more dense reinforced fabric. The pressure applied by the one or more sets of rollers can be also used to facilitate in the formation of the bond between the one or more mats and the fibers. In addition or alternatively, the reinforced fabric can be directed into an oven to form the bonding between the one or more mats and the fibers in the reinforced fabric. As illustrated in FIG. 4, the side ends of the two mats 40 can also be bonded together by a heat bond 70 during the heating process. This bond between the two mats can facilitate in the maintaining of the position of the fibers after the formation of the reinforced fabric. As can be appreciated, the formation of a bond between the mats is not required.

As described above, the reinforced fabric 10 is formed by one fiber group 20. As can be appreciated, the advantages of the present invention can be realized from a reinforced fabric having multiple fiber groups. The multiple fiber groups can be laid in a parallel or non-parallel relationship to one another. The sequence of laying each fiber group can be selected depending on the desired fiber group orientation for the reinforced fabric.

When more than one fiber group is used to form the reinforced fabric, one or more mats can be positioned between the fiber groups; however, this is not required.

As also described above, the reinforced fabric 10 is formed by one mat layer on the top and bottom side of the reinforced fabric. As can be appreciated, more than one mat can be used on the top and/or bottom side of the reinforced fabric. Likewise, when one or more mats are positioned between the top and bottom side of the reinforced fabric, one or more mats can be used. As can also be appreciated, the reinforced fabric can for formed such that only the top or bottom side of the reinforced fabric includes a mat. When such a design for the reinforced fabric is used, one or more mats can be positioned between the top and bottom side of the reinforced fabric; however, this is not required.

Once the reinforced fabric is formed, the reinforced fabric can be further processed by partially or fully coating, encapsulate and/or impregnating the reinforced fabric with one or more polymer materials.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

1-18. (canceled)

19. A method for forming a reinforced fabric comprising:
a) providing a first fiber group, said first fiber group including a plurality of fibers positioned substantially parallel to one another;
b) providing a mat, said mat having an outer surface that is formed of a material having a melting point that is less than the melting point of said fibers in said first fiber group;
c) laying said mat on said first fiber group; and,
d) heating said mat at a temperature and for a period of time to at least partially fuse or melt together said mat to a plurality of said fibers.

20. The method as defined in claim 19, including the step of providing a second mat, said second mat having an outer surface that is formed of a material having a melting point that is less than the melting point of said fibers in said first fiber group, said second mat positioned on another outer surface of said reinforced fabric or between a plurality of said fibers.

21. The method as defined in claim 20, wherein said step of heating causes said two mats to heat bonded together at least one side edge of said reinforced fabric.

22. The method as defined in claim 19, including the step of at least partially impregnating said first and second fiber groups with at least one polymer.

23. The method as defined in claim 19, wherein said step of heating includes feeding said mat and said first fiber group through at least one set of heated rollers, an oven, or combinations thereof.

24. The method as defined in claim 19, wherein said step of heating causes a plurality of intersecting threads in said mat to heat bond together.

25. The method as defined in claim 19, wherein said mat is positioned on an outer surface of said reinforced fabric.

26. The method as defined in claim 19, including the step of providing a second fiber group, said second fiber group including a plurality of fibers positioned substantially parallel to one another, said second fiber group laid on said first fiber group in a non-parallel relationship to said first fiber group.

27. The method as defined in claim 19, wherein said mat is not stitched to said fibers.

28. The method as defined in claim 19, wherein said mat includes a plurality of threads.

29. The method as defined in claim 28, wherein said mat includes a plurality of woven threads.

30. The method as defined in claim 28, wherein said mat includes a plurality of non-woven threads.
